(19) United States
(12) Patent Application Publication
(10) Pub. No.: US 2002/0158396 A1
(43) Pub. Date: Oct. 31, 2002

(54) Tooling fixture

(76) Inventors: Ricky Bennett, Flemington, NJ (US); Richard Lieske, Winona, MN (US); Andrew Dean Ure, Portland (GB); Jason Mark Edelstein, Weymouth (GB)

Correspondence Address: SHANKS & HERBERT, Intellectual Property, TransPotomac Plaza, 1033 N. Fairfax Street, Suite 306, Alexandria, VA, 22314, US

(21) Appl. No.: 09/843,149

(22) Filed: Apr. 27, 2001

(51) Int. Cl. B23Q 3/00

(52) U.S. Cl. 269/309

(57) ABSTRACT

A tooling fixture for aligning and supporting multiple substrates removed from a carrier for further processing, comprising a plurality of vacuum towers attached to a base for supporting said substrates, and a plurality of tapered pins attached to a secondary base for initially aligning said substrates, lifting them from said carrier, and supporting them until said substrates are supported by said vacuum columns.

### FIELD OF THE INVENTION

The present invention relates to a tooling fixture and method for simultaneous alignment and support of multiple, generally rectangular substrates for bulk processing and particularly for screen printing, placement machines or dispensing equipment.

### BACKGROUND OF THE INVENTION

Developments in electronics continuously result in more complex systems being contained in smaller packages, i.e., mobile phones. As printed circuit boards became smaller, it became common to manufacture them in panels of multiple boards that could be assembled as a single entity, until the increased accuracy required for newer smaller components could not be achieved. Therefore, handling circuit boards as single small boards again became necessary. At the same time, electronic components have become larger as more functionality has been integrated into a single integrated circuit and more than one integrated circuit plus resistors and capacitors have been assembled onto a substrate to form a single component. This has resulted in almost identical assembly methods being required for both small printed circuit boards and large components. Within the component industry, it is common to handle multiple substrates within carriers such as those manufactured to the JEDEC (Joint Electron Device Engineering Council) standard.

Fabrication of large volumes of electronic circuitry is economically accomplished using automated equipment. Typically, a viscous solder paste is applied to selected areas of a substrate through a stencil in a screen printing machine. Electronic components are then placed on the applied solder paste using a placement machine, often referred to as a pick-and-place machine. The substrate and components are then heated in a re-flow oven to a temperature sufficient to melt the paste, causing the paste to flow under leads of the components and corresponding pads of the substrate, thereby forming solder joints and completing the electronic circuit.

Inside a screen printing machine, a pair of conveyor belts may be used to support the substrate or carrier by its edges. The conveyor belts move the substrate or carrier into the machine and position it relative to the stencil. A tooling fixture below the underside of the substrate or carrier is raised to provide support during the printing process. The substrate or carrier and tooling are then raised until the top surface of the substrate or carrier contacts the stencil. A printhead applies the solder paste to the top surface of the stencil and presses the paste against the stencil. Pressure applied by the printhead forces solder through holes in the stencil and onto the top surface of the substrate. The tooling fixture prevents the substrate or carrier from bending or flexing away from the stencil as pressure is applied by the printhead.

The conveyor belts also move the substrate or carrier through a placement machine. After solder is applied to the substrate by the screen printing machine, the substrate is moved into the placement machine and positioned relative to a robotic pick-and-place head. A tooling fixture located below the substrate or carrier is raised to support the underside of the substrate or carrier. Under the control of a computer program that defines the proper location of each of the components of the circuit, the pick-and-place head sequentially presses each component onto its proper location on the substrate. The tooling fixture prevents the substrate from flexing or moving as the pick-and-place head applies pressure.

Substrates within a carrier tend to suffer from inaccurate and unrepeatable registration due to variations within individual carriers and the free play needed between the substrate and carrier to enable easy removal and replacement. This is a particular problem within a screen printer where the substrates need to be aligned to fixed images on the stencil. Therefore, high yield is difficult to maintain. Placement machines can compensate for individual registration by using alignment marks, known as fiducials, on each substrate. However the placement machine will have poor throughput due to the time taken to sequence each substrate individually.

### SUMMARY OF THE INVENTION

In view of the above-identified placement and position problems with known methods, i.e. stencil to multiple substrate mismatch and individual required alignment for placement machines reducing throughput capability, it is an object of the present invention to provide a tooling fixture that overcomes the limitations of needing to handle small circuit boards or substrates individually within a carrier in order to achieve a satisfactory alignment between the substrate and, for example, the stencil in a screen printing process.

It is another object of the invention to provide a tooling fixture that overcomes the loss of throughput when handling each substrate individually rather than in multiples.

It is yet another object of the invention to provide a tooling fixture that overcomes the loss of yield caused by the difficulty in obtaining a satisfactory alignment across an array of substrates within a carrier.

These objectives are satisfied by the present invention which provides a tooling fixture for simultaneously aligning and supporting multiple substrates. The tooling fixture of the present invention comprises: (1) a base plate comprising multiple mounting pins and multiple vacuum towers mounted thereon, each vacuum tower arranged to support one of said multiple substrates; (2) a secondary plate moveably mounted above said base plate on said mounting pins, said secondary plate comprising a corresponding opening for receiving each vacuum tower and mounting pin; (3) a plurality of tapered pins mounted on said secondary plate around each of said openings and arranged to align the substrate above each vacuum tower; and (4) a spring mounted on each of said mounting pins between said base plate and said secondary plate.

The above objectives are further satisfied by the present invention which provides a method of aligning and supporting multiple substrates for further processing. The method of the present invention comprises the steps of: (1) providing a tooling fixture having multiple tapered pins and vacuum columns for positioning and supporting multiple substrates; (2) moving said tooling fixture to a level to accommodate a carrier having said substrates positioned thereon; (3) positioning said carrier directly above said tooling fixture; (4) raising said multiple tapered pins through said carrier to contact and align said substrates, and lift them from the carrier; (5) raising said vacuum towers to contact said substrates; and (6) applying vacuum to said vacuum towers to hold the substrates in position thereon.

The foregoing method can advantageously be accomplished with the tooling fixture of the present invention, which provides a method of aligning and supporting multiple substrates for further processing, comprising the steps of: (1) providing a tooling fixture as recited above; (2) moving said tooling fixture to a level to accommodate a carrier having said substrates positioned thereon; (3) positioning said carrier directly above said tooling fixture; (4) raising said tooling fixture until said multiple tapered pins pass through said carrier to contact and align said substrates, and lift them from the carrier; (5) raising said base plate relative to said secondary plate to raise said vacuum towers to contact said substrates; and (6) applying vacuum to said vacuum towers to hold the substrates in position thereon.

Further objects, features, and advantages of the invention will become apparent from the detailed description and drawings that follow.

### BRIEF DESCRIPTION OF THE DRAWINGS

FIG. 1 is a commercially available carrier.

FIG. 2 is a perspective view of a tooling fixture according to an embodiment of the invention.

FIG. 3 is a perspective view of a tooling fixture according to another embodiment of the invention.

FIG. 4 is a perspective view of a tooling fixture with a carrier in a position over the fixture in accordance with an embodiment of the invention.

FIG. 5 is a cross sectional view of a tooling fixture of the invention with a carrier in a lowered position.

FIG. 6 is a cross sectional view of a tooling fixture of the invention having a carrier in an intermediate position.

FIG. 7 is a cross sectional view of a tooling fixture of the invention having a carrier in a final position.

### DETAILED DESCRIPTION OF A PREFERRED EMBODIMENT OF THE INVENTION

The invention will now be described in more detail with reference to the embodiments shown in the accompanying figures. The following described embodiments are only presented by way of example and should not be construed as limiting the inventive concept to any particular physical configuration. Also, while the following discussion describes the use of the system for the screen printing process; it is not limited to screen printing and can be used in any process where it is necessary or advantageous to have a substrate accurately aligned. Examples of other such processes are the placement of components onto a substrate and dispensing of viscous material onto a substrate.

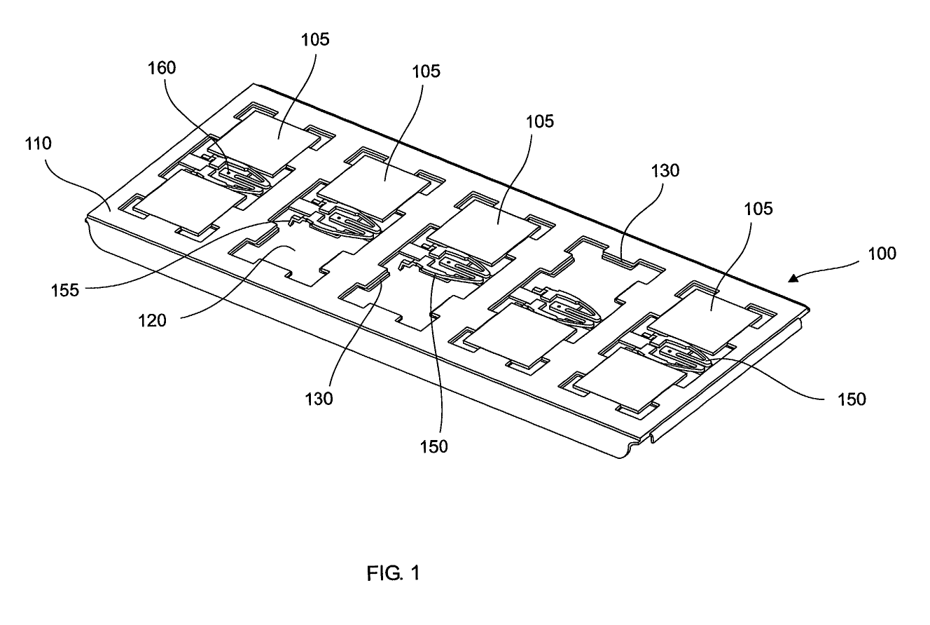

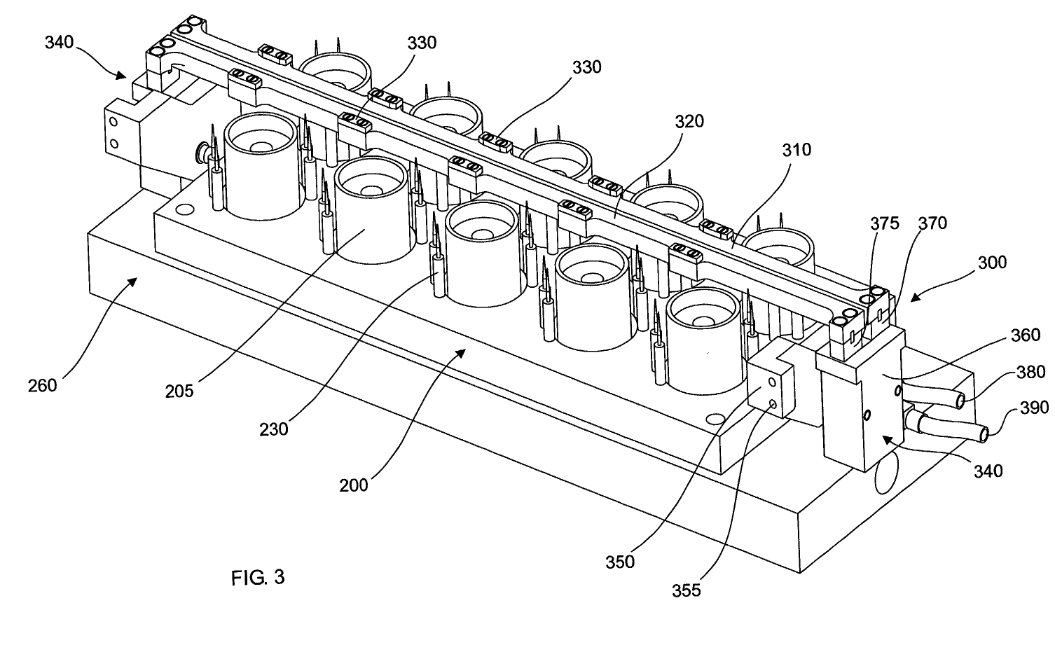

FIG. 1 shows a commercially available carrier 100 widely available within the industry and to better show its structure, it is only partially filled with substrates 105. A carrier is used in a screen printing process to hold and support multiple work pieces or substrates as they are being moved into the printing machine for processing. It holds a number of individual substrates 105 roughly positioned within recesses formed by cutouts 120 and ledges 130 in the upper surfaces 110 of the carrier. An example of a substrate according to the present invention is the base of the package for housing an integrated circuit such as a microprocessor. Other possible substrates can be any material onto which electronic components will be mounted. In the illustration, the carrier 100 has ten recesses 120 arranged in two rows. It should be noted that quantity, size and array layout is not limited to this arrangement. In some commercially available versions of the carrier, spring clips 150 are incorporated into the carrier in order to retain and release the substrates 105 within the carrier 100. The spring clips 150 are preferably spot-welded onto the carrier at positions 160. Each half of the spring clip 150 forms an independent spring and terminates in a leg 155 projecting down below the carrier 100. Normally the spring clip 150 will apply pressure to the edge of the substrate 105 holding it securely in the carrier. When a mechanism such as the spring clip release system 300 illustrated in FIG. 3, pushes the two legs 155 closer together, the pressure applied to the edge of the substrate 105 is released and said substrate can be removed or replaced in the carrier 100.

The carrier 100 may be transported into a printing machine in any conventional manner. Generally, the carrier 100 is belt driven between guide rails until it comes to rest against a stop in such a manner that it is fairly accurately positioned over the tooling fixture according to this invention within a printer.

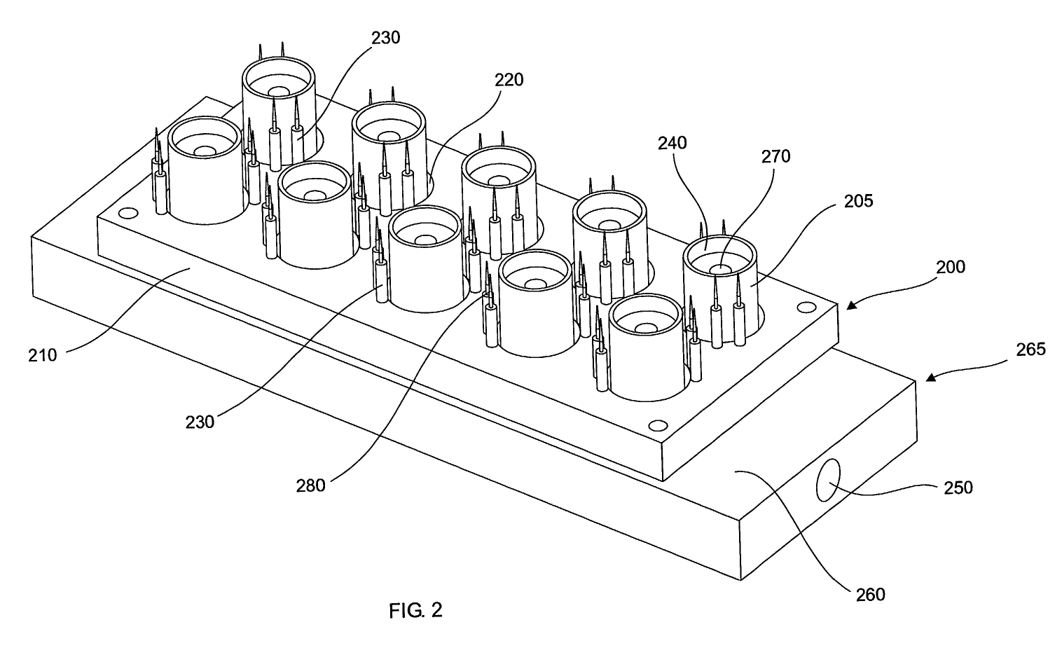

In FIG. 2, there is a vacuum tower 205 and a set of four tapered pins 230 associated with each substrate 105 within the carrier 100 for alignment and support. The tapered pins 230 are attached to secondary plate 210 by screws from the underside to form secondary unit 200. Each of the four tapered pins 230 are arranged to contact each side of opposing comers of substrate 105 (see FIG. 4). Raising the secondary unit 200 will raise the pins 230 and cause the tapered edge of said pins to make point contact with the edge of the substrate 105 and initially move said substrate until all four pins 230 contact the substrate 105 when said substrate will be in its required, aligned position. Continued raising of the pins 230 will lift the substrate 105 out of the carrier 100.

Minimal contact between the pins and the substrate minimizes friction and provides more efficient repeatable centering.

The vacuum towers 205 are mounted directly onto a base plate 260 to form a base unit 265. Vacuum from an external source is supplied via a pipe (not shown) to port 250 and then through internal channels (not shown) in base plate 260 to each tower 205, where it is connected via bore 270 to the vacuum chamber 240 at the top of each tower 205. The vacuum is used to clamp the substrate 105 to the top of each tower 205 when in its fully raised position. The vacuum chamber 240 can be left open as shown or in an alternate embodiment, may be fitted with an optional vapor permeable plate. The plate may be comprised of a rigid or flexible material perforated with a series of small holes (not shown). Alternatively, other pervious material, such as foam or sintered aluminum, may also be used for the plate to provide an optional top surface of the vacuum towers 205. The plate may provide better support for some substrates and will limit the loss of vacuum for substrates with holes in them. Additionally, where the substrate has components already fitted to its underside, a top plate specially machined to accept these components can be used.

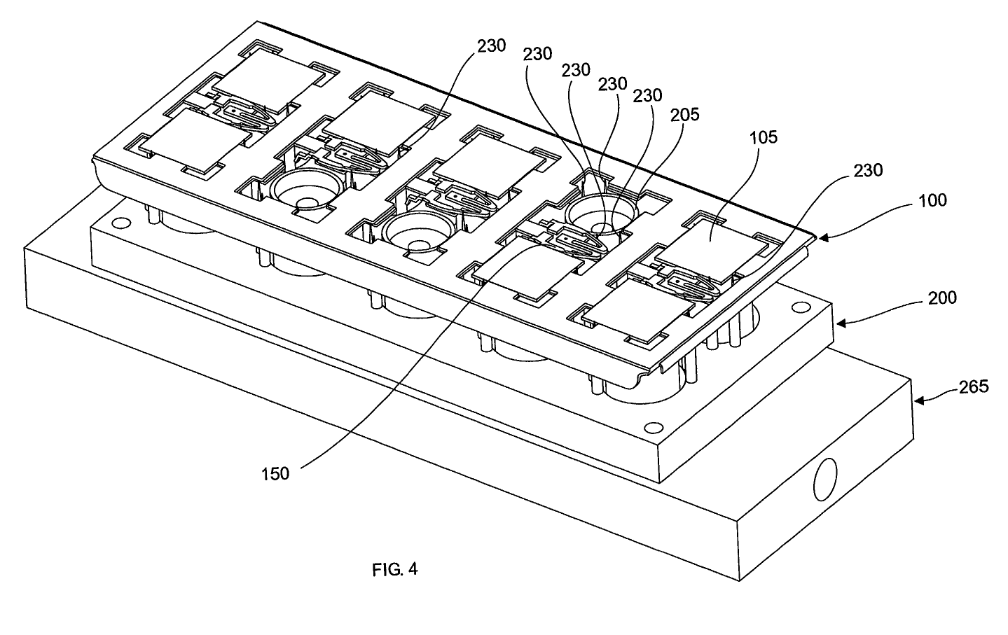

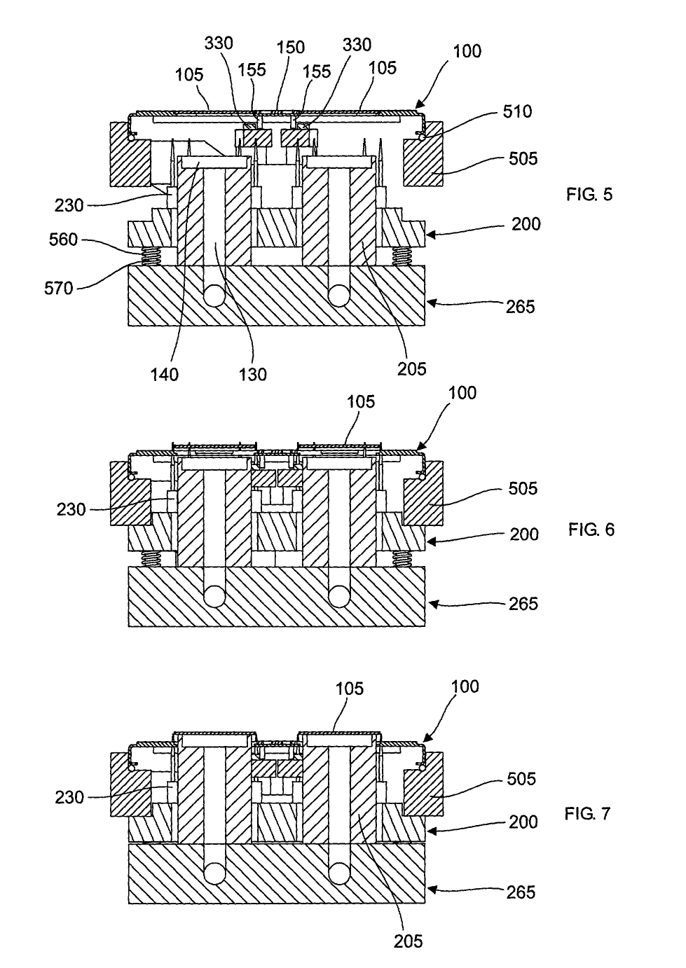

The plate 210 of secondary unit 200 has clearance holes 220 for the vacuum towers 205 and is held at a suitable height above the base plate 260 by a series of location pins 560 and springs 570 (see FIG. 5). This height is set such that with the springs 570 fully extended a substrate 105 will be supported by pins 230 clear of the top of tower 205 as shown in FIG. 6, and when said spring is fully compressed the tower 105 will lift the substrate 105 clear of the pins 230 as shown in FIG. 7. The full functioning of the complete system is described in conjunction with FIGS. 5-7 below.

FIG. 3 shows an alternate embodiment of the invention with an optional spring clip release system included. The optional spring clip release mechanism 300 includes two longitudinal bars 310 and 320 with actuator blocks 330 screwed to them in positions to compress the legs 155 of the spring clips 150 in FIG. 1. Each end of the bars 310 and 320 are attached to similar operating mechanism 340.

Each mechanism 340 has a fixed bracket 350 that is attached to a guide rail of the printing machine by screws through holes 355. Attached to this bracket 350 is pneumatic gripper 360 of the type supplied by SMC Pneumatics (UK) Ltd as model MHZ2-16D “ParallelStyle Air Gripper”. This pneumatic gripper 360 is connected via pipes 380 and 390 to a source of compresses air (not shown). The pneumatic gripper has two jaws 370 and 375 that when compressed air is applied via pipe 380 will move closer together and conversely when compressed air is applied via pipe 390 will move further apart. Bar 310 is screwed to jaw 370 and bar 320 to jaw 375. Thus when compressed air is applied via pipe 380 the bars 310, 320 and associated actuator blocks 330 will move closer together compressing the springs 150 and releasing the substrates 105 within carrier 100 and when compressed air is applied via pipe 390 the bars 310, 320 and associated actuator blocks 330 will move further apart releasing the springs 150 and reclamping the substrates 105 within carrier 100.

FIG. 4 shows a perspective view of the tooling fixture of FIG. 2 having carrier 100 as in FIG. 1 attached and positioned for placement in the printing machine. In FIG. 4 the substrate 105 is resting on the carrier 100 and is being held by the spring clip 150.

Within a screen printing machine it is a normal feature to have a mechanism for raising a tooling system up to support the underside of the product to be printed and to further raise it into contact with the stencil for printing. In placement and dispensing machines it is also normal to have such a mechanism for raising a tooling system up to support the underside of the product being processed. The base unit 265 of any of the above embodiments is mounted on this normal raising mechanism.

The operation of the tooling fixture according to this invention will now be explained with reference to FIGS. 5-7.

FIG. 5 shows the tooling fixture, units 265 and 200 in their lowered positions so that the tapered pins 230 and vacuum towers 205 are all below the level of the carrier 100, enabling the carrier 100 to be transported into the printer on drive belts 510 and guide rails 505 to a position directly above the tooling. Also, as the carrier 100 is fitted with the optional spring clips 150, the optional spring clip release mechanism 300 is fitted and is shown with the actuator blocks 330 set in their furthest apart positions so as to be clear of the spring legs 155 as the carrier 100 is transported into the printer.

When the carrier 100 and substrates 105 are in position as shown in FIG. 5, the compressed air supply to the spring clip release mechanism 300 is switched to move the actuator blocks 330 closer together and act on the spring legs 155 releasing the pressure of the springs 150 from the edge of substrates 105 and allowing room for said substrates to move within the carrier. Then the printers lifting mechanism (not shown) will start to raise the base unit 265 and through springs 560 the secondary unit 200. At the same time it is normal to switch on the vacuum supply to the towers 205 although it will have no effect until part way through the vertical movement.

As the unit is raised, the tapered pins 230 will rise up between the carrier 100 and substrates 105 and normally one of said pins will make contact with the edge of a substrate before any other. Then the taper of said pin will push said substrate sideways within the carrier 100 and as each tapered pin 230 makes contact with said substrate it will also push it sideways until all four tapered pins 230 around a substrate 105 have made contact. When all of the pins have made contact, the substrate will be in its required aligned position and the tapered pins 230 will then start to lift the substrate 105 vertically out of the carrier 100. When the substrates 105 are clear of the carrier 100, the secondary unit 200 will make contact with underside of the guide rails 505 as shown in FIG. 6.

Contact between secondary unit 200 and guide rails 505 will stop the pins rising any further while the printer lifting mechanism will continue to cause the base unit 265 and vacuum towers 205 to rise compressing springs 560. The vacuum towers 205 will eventual make contact with the underside of the substrates 105 where they will be held in the aligned position on the top of said towers by the vacuum. Base unit 265 will continue to rise until the springs 560 have been fully compressed and the substrates 105 have been lifted clear of the tapered pins 230 as shown in FIG. 7. At this stage, lifting of the full system of base unit 265, secondary unit 200, guide rails 505, spring clip release mechanism 300, carrier 100 and substrates 105 may continue until the substrates reach the required level for printing as determined by the printing machine.

Thus in one vertical movement of the tooling fixture according to this invention, multiple substrates 105 have been individually aligned by pins 230, lifted clear of a carrier 100 and supported by vacuum towers 205 ready for processing by a screen machine or any other process.

After printing the tooling is lowered, when clear of the stencil the vacuum is switched off and the substrate 105 is lowered onto the tapered pins 230 and then positioned back into the recesses 120 in the carrier 100. Next, compressed air to the optional spring clip release mechanism 300 is switched to clip the substrate 105 back onto the carrier 100. When fully lowered the belt feed system transports the carrier out of the printer and a new carrier 100 into the printer to recommence the process.

Although the invention has been described above in detail for the purpose of illustration, it is understood that numerous variations and alterations may be made by the skilled artisan without departing from the spirit and scope of the invention defined by the following claims.

What is claimed is:

1. A tooling fixture for simultaneously aligning and supporting multiple substrates comprising:
a base plate comprising multiple mounting pins and multiple vacuum towers mounted thereon, each vacuum tower arranged to support one of said multiple substrates;
a secondary plate moveably mounted above said base plate on said mounting pins, said secondary plate comprising a corresponding opening for receiving each vacuum tower and mounting pin;
a plurality of tapered pins mounted on said secondary plate around each of said openings and arranged to align the substrate above each vacuum tower; and
a spring mounted on each of said mounting pins between said base plate and said secondary plate.

2. The tooling fixture of claim 1, wherein each of said vacuum towers comprises a tubular body having a longitudinal bore therein connected to a vacuum source.

3. The tooling fixture of claim 2, wherein said base plate further comprises internal channels from a port in said base plate to said longitudinal bore in each of said vacuum towers.

4. The tooling fixture of claim 1, further comprising a top plate on top of each of said vacuum towers.

5. The tooling fixture of claim 4, wherein said top plates are comprised of foam.

6. The tooling fixture of claim 4, wherein said top plates are comprised of sintered aluminum.

7. The tooling fixture of claim 4, wherein said top plate has perforations therein.

8. The tooling fixture of claim 4, wherein said top plate has depressions therein to accept substrates with components fitted thereon.

9. The tooling fixture of claim 1, wherein at least four tapered pins are located around each opening in said secondary plate.

10. The tooling fixture of claim 1, wherein said vacuum columns extend beyond the ends of the tapered pins when the springs are fully compressed.

11. The tooling fixture of claim 1, further comprising a release system for spring clips in a substrate carrier.

12. The tooling fixture of claim 11, wherein said spring clip release system comprises two longitudinal bars having actuator blocks mounted thereon positioned to compress legs of corresponding spring clips in said carrier; means for moving said bars to compress said legs; and said spring clip release system is mounted to a guide rail of a printing machine, so said secondary plate and said base plate can move independently of movement of said release system.

13. The tooling fixture of claim 12, wherein said means for moving said bars comprises a pneumatically actuated gripper.

14. The tooling fixture of claim 13, wherein said pneumatically actuated gripper is comprised of two jaw members, that are moveable with respect to one another to approach one another or move away from one another upon the selective application of pneumatic pressure, which contact said longitudinal bars.

15. A method of aligning and supporting multiple substrates for further processing, comprising the steps of:
providing a tooling fixture having multiple tapered pins and vacuum columns for positioning and supporting multiple substrates;
moving said tooling fixture to a level to accommodate a carrier having said substrates positioned thereon;
positioning said carrier directly above said tooling fixture;
raising said multiple tapered pins through said carrier to contact and align said substrates, and lift them from the carrier;
raising said vacuum towers to contact said substrates; and
applying vacuum to said vacuum towers to hold the substrates in position thereon.

16. The method of claim 15, further comprising raising said vacuum tower to lift said substrate clear of said tapered pins.

17. The method of claim 15 further comprising applying a viscous material onto said substrate.

18. The method of claim 15 further comprising placing one or more components on said substrate.

19. The method of claim 15, further comprising the step of energizing a spring release system to release said substrates from said carrier.

20. A method of aligning and supporting multiple substrates for further processing, comprising the steps of:
providing a tooling fixture as recited in claim 1;
moving said tooling fixture to a level to accommodate a carrier having said substrates positioned thereon;
positioning said carrier directly above said tooling fixture;
raising said tooling fixture until said multiple tapered pins pass through said carrier to contact and align said substrates, and lift them from the carrier;
raising said base plate relative to said secondary plate to raise said vacuum towers to contact said substrates; and
applying vacuum to said vacuum towers to hold the substrates in position thereon.

21. The method of claim 20, wherein said base plate is raised sufficiently relative to said secondary plate for the vacuum columns to lift the substrates clear of the tapered pins.

22. The method of claim 20, further comprising the step of activating a spring clip release system to release said substrates from said carrier.

23. The method of claim 22, wherein said activation of said spring clip release system comprises:
applying pressurized air to a spring clip release mechanism which results in the movement of longitudinal bars containing actuator blocks closer together until said actuator blocks contact and compress the legs of said spring clips, thereby releasing said substrates from said spring clips.
